(19) United States
(12) Patent Application Publication
(10) Pub. No.: US 2005/0220237 A1
(43) Pub. Date: Oct. 6, 2005

(54) Method and arrangement for sampling

(76) Inventors: Harald Sandner, Marzling (DE); Joerg Goller, Zweikirchen (DE)

Correspondence Address: TEXAS INSTRUMENTS INCORPORATED, P O BOX 655474, M/S 3999, DALLAS, TX, 75265, US

(21) Appl. No.: 11/096,071

(22) Filed: Mar. 31, 2005

(30) Foreign Application Priority Data
Apr. 2, 2004 (DE) 10 2004 016359.6

(51) Int. Cl. H04B 3/46

(52) U.S. Cl. 375/355

(57) ABSTRACT

In the proposed method of sampling data that are related to a clock signal, a three test samples are taken from the same data at positions in time spaced from each other by fixed delays by shifting the clock signal in time with respect to the data until the test samples taken from the same data have an identical value. A shifted clock signal is used to take validated samples of the data. Since the clock is shifted in time in relation to the data so that all test samples have an identical value, that value is the true value of a datum sampled within a period of time from the moment of the first test sample to the moment of the last test sample, and a validated data sample is obtained.

### CROSS REFERENCE TO RELATED APPLICATIONS

This application claims priority under 35 USC § 119 of German Application Ser. No. 10 2004 016359.6, filed Apr. 2, 2004.

### FIELD OF THE INVENTION

The present invention relates to a method of sampling data that are related to a clock signal and to a data sampling arrangement.

### BACKGROUND OF THE INVENTION

Due to various reasons, data at a parallel interface of data communication equipment can be delayed with respect to a system clock. The amount of delay cannot be predicted precisely because of its dependency on supply, line length, process etc. Valid samples of the data are not obtained unless the sampling occurs within a stable period of the data signal at some distance from a rising/falling edge and the following falling/rising edge.

### SUMMARY OF THE INVENTION

The present invention provides a method that permits the clock signal to be automatically aligned with the data to be sampled, thereby ensuring that all data samples are valid.

Specifically, the invention provides a method of sampling data that are related to a clock signal. A plurality of test samples are taken from the same data at positions in time spaced from each other by fixed delays by shifting the clock signal in time with respect to the data until the test samples taken from the same data have an identical value. A shifted clock signal is used to take validated samples of the data. Since the clock is shifted in time in relation to the data so that all test samples have an identical value, that value is the true value of a datum sampled within a period of time from the moment of the first test sample to the moment of the last test sample, and a validated data sample is obtained. If one of the test samples has a value different from that of other test samples, then it was taken before or after an edge of the data signal, i.e. at a moment where valid data samples cannot be obtained.

In a preferred embodiment, a first test sample is taken with a variably delayed clock signal, a second test sample is taken with a clock signal that is delayed by a first fixed amount with respect to the variably delayed clock signal and at least a third test sample is taken with a clock signal further delayed by a second fixed amount with respect to the variably and by the first fixed amount delayed clock signal. While more than three test samples could be used, a number of three is sufficient and therefore considered optimum.

In a further development of the method, the clock is adjusted in time with respect to the data by an initial step wherein the clock signal is incrementally delayed with respect to the data from a condition where all test samples of the same data have an identical value to a condition where two of the test samples have a value different from each other and then to a condition where all test samples have an identical value.

According to another aspect of the invention, a data sampling arrangement with a data input port, a clock input port and a data output port is provided. The arrangement comprises:
an adjustable delay member that has an input connected to the clock input port, a control terminal and an output,
a first fixed delay member that has an input connected to the output of the adjustable delay member,
a second fixed delay member that has an input connected to the output of the adjustable delay member,
a first D-flip-flop that has a data input connected to the data input port, a clock input connected to the output of the adjustable delay member and a data output,
a second D-flip-flop that has a data input connected to the data input port, a clock input connected to the output of the first fixed delay member and a data output,
a third D-flip-flop that has a data input connected to the data input port, a clock input connected to the output of the first fixed delay member and a data output,
and a state machine that has a first data input connected to the output of the first D-flip-flop, a second data input connected to the output of the second D-flip-flop, a third data input connected to the output of the third D-flip-flop, a clock input connected to the clock input port and a control output connected to the control terminal of the adjustable delay member.

The state machine has a state where the delay of the adjustable delay member is incrementally increased, a state where the delay of the adjustable delay member is decrementally reduced and a state where the delay of the adjustable delay member is maintained. In the latter state validated data samples are delivered at the data output port. The changes between the states of the state machine are determined based on a comparison of test samples appearing at the first, second and third data inputs of the state machine.

When the data to be sampled are transmitted on a bus with n parallel bit lines, each sample is considered as an array with n elements.

### BRIEF DESCRIPTION OF THE DRAWINGS

FIG. 1 is a schematic diagram of a data sampling arrangement;

FIG. 2 is a chart showing states of a state machine and changes between the states; and

FIG. 3 is a signal diagram illustrating the inventive method.

### DETAILED DESCRIPTION OF THE DRAWINGS

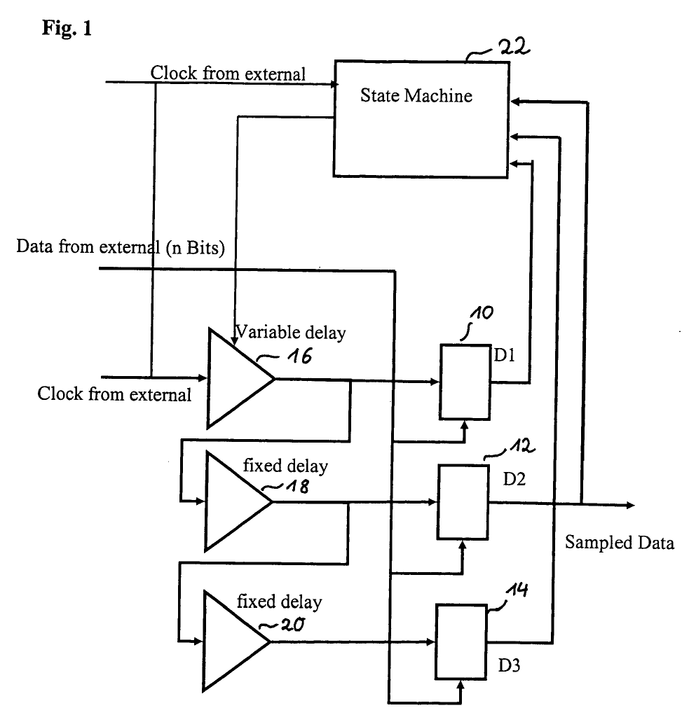

With reference to FIG. 1, an inventive data sampling arrangement that uses the inventive method of sampling data is shown. External data arrive at a data input port and a related external clock signal arrives at a clock input port. For sampling the data at three different time positions, the external data signal is applied to data inputs of three D-flip-flops 10, 12 and 14. The data may be serial data on a single line or parallel data transmitted on an n-bit bus. The external clock signal is used to sample the data at the different time positions. Therefore, the clock signal must be delayed in a specific way. The clock input port is connected to an input of an adjustable delay circuit 16. With adjustable delay circuit 16 the clock signal is shifted in time by a variable amount before it is applied to a clock input of D-flip-flop 10 to take a first test sample D1 of the data. The shifted clock signal that is output from variable delay circuit 16 is also applied to an input of a first fixed delay circuit 18. Fixed delay circuit 18 shifts the already shifted clock signal by a fixed amount. An output of fixed delay circuit 18 is connected to a clock input of D-flip-flop 12 to take a second test sample D2 of the data. The output of fixed delay circuit 18 is also connected to an input of a second fixed delay circuit 20. Fixed delay circuit 20 shifts the clock signal that has already been shifted twice by another fixed amount. An output of fixed delay circuit 20 is connected to a clock input of D-flip-flop 14 to take a third test sample D3 of the data.

The three delay circuits 16, 18 and 20 provide three delayed clock signals that are in fixed time positions to each other and that can be shifted together variably in time while maintaining their fixed time relation. Thus, the data signal applied to the three D-flip-flops 10, 12 and 14 is sampled with three differently delayed clock signals at positions in time spaced from each other. Therefore, the D-flip-flops 10, 12, 14 each output another test sample D1, D2 respectively D3, which are all applied to different data inputs of a state machine 22. For a serial data signal on a single line, each test sample corresponds to one bit, for a parallel data signal on an n-bit bus; each sample is considered an element of an n-dimensional array. State machine 22 has also a clock input that receives the external undelayed clock signal and a control output connected to a control terminal of adjustable delay circuit 16 for sending commands to adjustable delay circuit 16 to increment or decrement the variable delay. The data output of D-flip-flop 12 is also connected to the data output port.

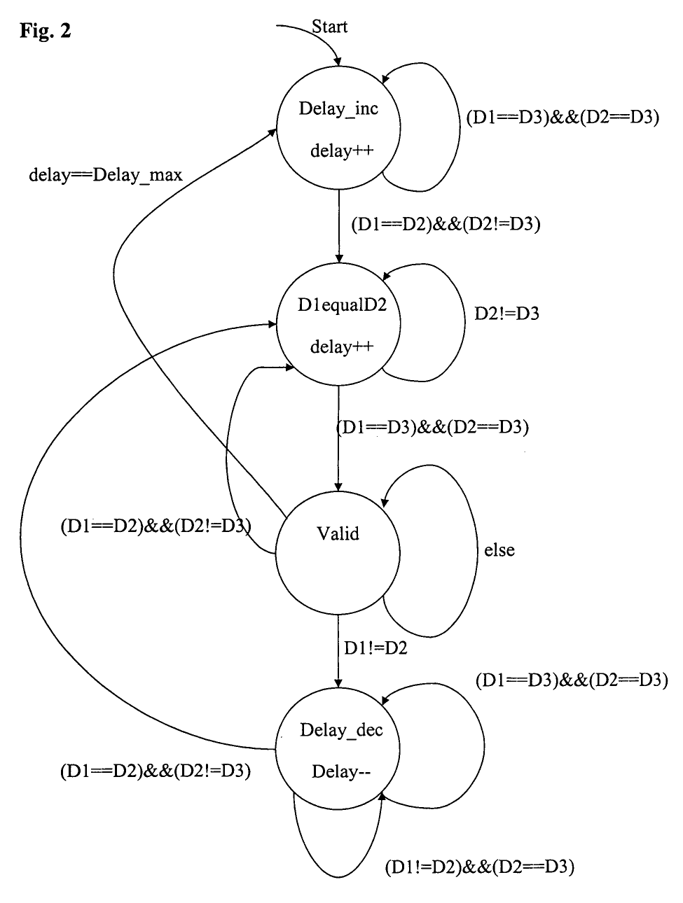

With reference to FIG. 2, the function of state machine 22 will be explained in more detail. The circles represent different states of state machine 22 corresponding to different commands given to adjustable delay circuit 16 that is shown in FIG. 1. In the chart of FIG. 2 the variable delay of adjustable delay circuit 16 is assumed to be on its minimum as a starting condition. Having a minimum variable delay, in the first state “Delay_inc” the variable delay is incrementally changed and state machine 22 compares the test samples D1, D2 and D3. If test sample D3, which is taken with the most delayed clock, is not equal to the other two test samples D1 and D2, state machine 22 will change state. Next state is “D1equalD2”, the delay is further increased until all three test samples will be identical and state machine 22 will again change state. Next state is “Valid”. In this state, test sample D2 is taken as a valid data sample and transmitted to the data output port of the data sampling arrangement. This state will be maintained until a signal drift occurs and the three test samples are not identical any more. Then state machine 22 will either change to the fourth state “Delay_dec” and decrement the delay or return into state “D1equaID3”. On the left hand side of FIG. 2 other possible return paths between states are shown, on the right are the conditions for remaining in the same state.

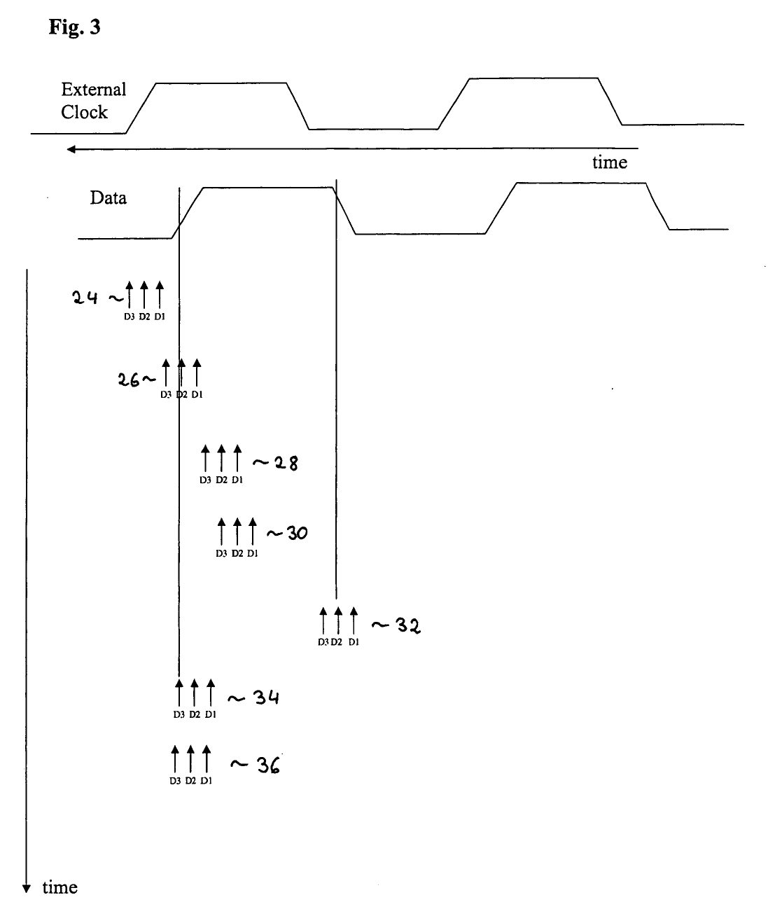

FIG. 3 visualizes the time positions of test samples D1, D2 and D3 in relation to a data signal. Arrows D1, D2 and D3 symbolize the moment or the time position, when test samples are taken. The three arrows remain always in a fixed time relation to each other and are delayed together in relation to the data signal. In FIG. 3 it is assumed, that adjustable delay circuit 16 starts with minimum delay. In the first test sample group 24 all test samples are identical, they all take the low value of the data signal, but as it is the first sample group and delay is minimum, the delay will be incremented. Test sample group 26 shows the new time relation between the time positions for the test samples and the data signal. Test sample D3 is now different from test samples D1 and D2. After taking test sample group 26 and comparing the three test samples, state machine 22 will therefore change to state “D1equaID2”. With test sample group 28 all test samples are again equal, they all take the high value of the data signal, and state machine 22 will change to state “Valid” and remain there for group 30. The test sample groups 32, 34 and 36 show situations, where a signal drift, which may be a drift of the data signal or of the clock signal, has occurred and a new change of state is necessary.

With the inventive method of sampling data, a validated data sample can be taken even if a drift between clock signal and related data signal occurs.

1. A method of sampling data that are related to a clock signal, wherein a plurality of test samples are taken from the same data at positions in time spaced from each other by fixed delays by shifting the clock signal in time with respect to the data until the test samples taken from the same data have an identical value and a shifted clock signal is used to take validated samples of the data.

2. The method of claim 1, wherein the clock signal is delayed with an incrementally/decrementally variable delay and additionally delayed by a fixed amount.

3. The method of claim 2, wherein a first test sample is taken with a variably delayed clock signal and a second test sample is taken with a clock signal delayed by a first fixed amount with respect to the variably delayed clock signal and at least a third test sample is taken with a clock signal further delayed by a second fixed amount with respect to the variably and by the first fixed amount delayed clock signal.

4. The method of claim 3, wherein the second test sample is taken as a validated sample.

5. The method of claim 1 and comprising an initial step wherein the clock signal is incrementally delayed with respect to the data from a condition where all test samples of the same data have an identical value to a condition where two of the test samples have a value different from each other and then to a condition where all test samples have an identical value.

6. The method according to any of the preceding claims, wherein the data are parallel data on an n-bit bus and each sample is considered an element of an n-dimensional array.

7. A data sampling arrangement with a data input port, a clock input port and a data output port, comprising
an adjustable delay member that has an input connected to the clock input port, a control terminal and an output,
a first fixed delay member that has an input connected to the output of the adjustable delay member,
a second fixed delay member that has an input connected to the output of the first fixed delay member,
a first D-flip-flop that has a data input connected to the data input port, a clock input connected to the output of the adjustable delay member and a data output,
a second D-flip-flop that has a data input connected to the data input port, a clock input connected to the output of the first fixed delay member and a data output,
a third D-flip-flop that has a data input connected to the data input port, a clock input connected to the output of the second fixed delay member and a data output,
and a state machine that has a first data input connected to the output of the first D-flip-flop, a second data input connected to the output of the second D-flip-flop, a third data input connected to the output of the third D-flip-flop, a clock input connected to the clock input port and a control output connected to the control terminal of the adjustable delay member;
the state machine having a state where the delay of the adjustable delay member is incrementally increased, a state where the delay of the adjustable delay member is decrementally reduced and a state where the delay of the adjustable delay member is maintained and validated data samples are delivered at the data output port.

8. The data sampling arrangement of claim 7, wherein the data output of the second D-flip-flop is connected to the data output port.

9. The data sampling arrangement of claim 7, wherein the delay of the second fixed delay member is the same as that of the first fixed delay member.

10. The data sampling arrangement according to claim 7, wherein changes between the states of the state machine are determined based on a comparison of test samples appearing at the first, second and third data inputs of the state machine.
